(19) United States
(12) Patent Application Publication
(10) Pub. No.: US 2005/0078139 A1
(43) Pub. Date: Apr. 14, 2005

(54) Method and apparatus for detecting edge of paper and borderless printing method using the method and apparatus

(75) Inventors: Kyung-pyo Kang, Suwon-si (KR); Tae-young Kim, Suwon-si (KR); Hyoung-il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/927,521

(22) Filed: Aug. 27, 2004

(30) Foreign Application Priority Data
Aug. 29, 2003 (KR) 2003-60248

(51) Int. Cl. B41J 29/393

(52) U.S. Cl. 347/19

(57) ABSTRACT

A method and apparatus for detecting an edge of paper and a borderless printing method. The method involves feeding paper through a printing apparatus, outputting a sensing signal for the paper using a sensor disposed adjacent to a print head, and calculating a gradient of the sensing signal and detecting an edge of the paper based on the gradient of the sensing signal.

### CROSS-REFERENCE TO RELATED APPLICATIONS

This application claims the benefit under 35 U.S.C. §119(a) of Korean Patent Application No. 2003-60248, filed in the Korean Intellectual Property Office on Aug. 29, 2003, the entire contents of which are incorporated herein by reference.

### BACKGROUND OF THE INVENTION

1. Field of the Invention

The present invention relates to a method and apparatus for detecting an edge of paper and a borderless printing method using the method and apparatus. More particularly, the present invention relates to a method and apparatus for detecting an edge of paper when the paper is fed, and a borderless printing method using the method and apparatus.

2. Description of the Related Art

When a user attempts to print an image on a paper without any upper, lower, left, and right margins, some portions of the image may not be printed at locations where they should be printed in a borderless printing process if the edges of the paper are not precisely detected. In the case of printing the image on a lower end portion of the paper for example, the paper, which is fed by feeding rollers into a printing zone, may be accidentally fed by a predetermined distance set in advance when it slides out of the feeding rollers. This results because once the paper leaves the feeding rollers, it cannot be firmly held solely by the discharging rollers. This type of paper feeding error may deteriorate the quality of printing.

In order to solve this problem, a conventional method of detecting an edge of paper has been suggested which is disclosed in U.S. Pat. No. 6,352,332 issued to Steven Walker, entitled “Method And Apparatus For Printing Zone Print Media Edge Detection”, the entire contents of which are incorporated herein by reference.

FIGS. 1A and 1B are graphs illustrating a conventional method of detecting an edge of paper disclosed in U.S. Pat. No. 6,352,332, referenced above. Referring to FIG. 1A, an optical sensor scans across a sheet of paper to detect an edge of the paper, thereby obtaining reflectance measurement data 301 at each position on the paper. The reflectance measurement data 301 illustrates that the reflectance from the paper is as high as 3300, and gradually decreases toward the edge of the paper. Once the reflectance measurement data 301 reaches a measurement point off the paper, it plummets to about 490 on a pivot. A slope of a shape curve 302 is obtained by respectively averaging high reflectance values and low reflectance values of a plurality of sample data, and substituting the averages and a field of view of the optical sensor into Equation (1) below.

$$Slope = \frac{\begin{matrix}( Average of high reflectance values ) - \\ ( Average of low reflectance values )\end{matrix}}{Field of view} \qquad ( 1 )$$

A shape curve 302′ of FIG. 1B is then obtained by moving the shape curve 302, as indicated by the arrow of FIG. 1A, by a predetermined error in order to detect an actual edge of the paper by referring to a reference edge. In the conventional method of FIGS. 1A and 1B, a vertex 303 at which reflectance begins to plummet from its highest level, i.e., 250(*1/600 inches), is determined as corresponding to the edge of the paper.

However, in the conventional method of detecting an edge of paper, it is rather difficult to determine at which point on the paper the slope of the shape curve 302 begins varying, i.e., the location of the vertex 303, resulting in a wide variation of the location of the vertex 303.

Accordingly, a need exists for a system and method for detecting an edge of paper which can be easily implemented and which is not subject to the measurement errors noted above.

### SUMMARY OF THE INVENTION

Accordingly, the present invention solves the above and other problems by providing a method and apparatus for detecting an edge of paper by using the output power of an alignment sensor.

The present invention also provides a borderless printing method that prints an image borderlessly on paper by detecting an edge of the paper and determining a stop position of the paper using the detected edge.

According to an object of the present invention, a method is provided for detecting an edge of paper. The method involves feeding paper, outputting a sensing signal for the paper, and calculating a gradient of the sensing signal and detecting an edge of the paper based on the gradient of the sensing signal.

According to another object of the present invention, an apparatus is provided for detecting an edge of paper. The apparatus includes a paper feeding unit which feeds paper, an alignment sensor which outputs a sensing signal for the paper in response to a control signal, a detector which calculates a gradient of the sensing signal and detects an edge of the paper based on the gradient of the sensing signal, and a controller which controls a feeding speed of the paper by controlling the paper feeding unit and outputs the control signal to the alignment sensor.

According to still another object of the present invention, a borderless printing method is provided. The borderless printing method involves feeding paper, periodically outputting a sensing signal for the paper, calculating a gradient of the sensing signal and detecting an edge of the paper based on the gradient of the sensing signal. The method then provides for placing a leading edge of the paper under a rear end of the nozzles used for printing to fix the paper, and printing data on the paper by using the nozzles.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are graphs illustrating a conventional method of detecting an edge of paper;

FIG. 2 is a schematic view illustrating a printer that includes an apparatus for detecting an edge of paper according to an exemplary embodiment of the present invention;

FIG. 3A illustrates an example of the variation of an operating state of a feeding roller during the time lapse from the time when paper is fed, to the time when the feeding of the paper stops;

FIG. 3B illustrates an example of the output signal of an alignment sensor;

FIG. 3C illustrates an example of the output signal of a detector;

FIG. 4 is a flowchart illustrating a paper edge detection and printing process according to an exemplary embodiment of the present invention;

FIG. 5 is a detailed flowchart illustrating a process of detecting an edge of paper every 1 ms according to an exemplary embodiment of the present invention;

FIG. 6 is a flowchart illustrating a borderless printing method according to an exemplary embodiment of the present invention;

FIG. 7 is a diagram illustrating a borderless printing process example at a leading end of paper; and

FIG. 8 is a diagram illustrating a borderless printing process example at a rear end of the paper.

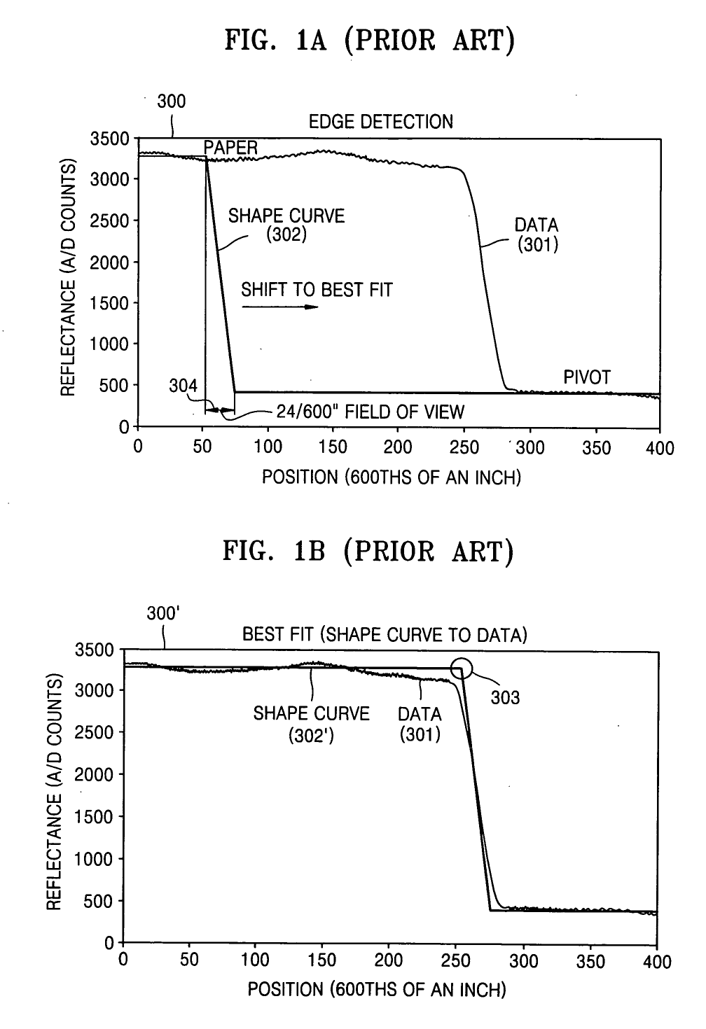

Throughout the drawings, like reference numerals will be understood to refer to like parts, components or structures.

### DETAILED DESCRIPTION OF THE EXEMPLARY EMBODIMENTS

The present invention will now be described in greater detail with reference to the accompanying drawings, in which exemplary embodiments of the invention are shown.

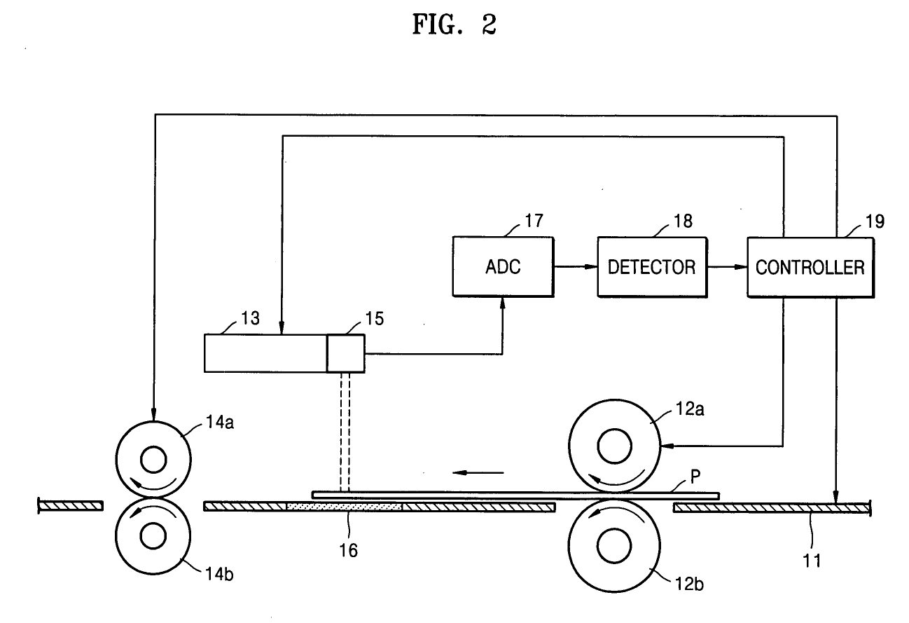

FIG. 2 is a schematic view illustrating a printer that includes an apparatus for detecting an edge of paper according to an exemplary embodiment of the present invention. Referring to FIG. 2, the printer includes a platen 11, feeding rollers 12a and 12b that advance paper P toward a printing zone, discharging rollers 14a and 14b which discharge the paper out of the printer after a printing process is complete, a head 13 which is equipped with an ink cartridge and which performs the printing process by injecting ink onto the paper P through nozzles, and an alignment sensor 15 which is installed at one side of the head 13 and outputs a sensing signal when sensing the paper P. The alignment sensor 15 is preferably an optical sensor that irradiates light on the paper P and converts the amount of light reflected from the paper P into an electric signal. The alignment sensor 15 is preferably installed at a leading end of the head 13 in a direction in which the paper P is fed (hereinafter, referred to as a paper feeding direction). A black material is formed on the entire surface of the sensing zone 16. The black material absorbs light such that the sensing zone 16 is easily distinguishable from the paper P that reflects light.

The printer also includes an analog-to-digital converter (ADC) 17 which converts an analog signal received from the alignment sensor 15 into a digital signal, a detector 18 which detects an edge of the paper P by processing the digital signal output from the ADC 17, and a controller 19 which aligns the detected edge of the paper P with nozzles (not shown) disposed at a rear end of the head 13. The controller 19 transmits a control signal-to control the alignment sensor 15, and further drives the head 13, controls the feeding rollers 12a and 12b, and controls the discharging rollers 14a and 14b.

The edge of the paper P is detected in the following manner. The controller 19 advances the paper P into the printing zone by driving the feeding rollers 12a and 12b. When the paper P proceeds toward the printing zone under the head 13, the controller 19 calculates the distance travelled by the paper P based on driving signals of the feeding rollers 12a and 12b. When it is determined that the paper P has proceeded a sufficient distance such that a leading end thereof is disposed under the alignment sensor 15, the alignment sensor 15 irradiates light onto the paper P every 1 ms. The alignment sensor 15, which is attached to the leading end of the head 13, detects desired information by irradiating light onto the paper P before a printing process begins.

The controller 19 scans a leading end portion of the paper P with the use of the alignment sensor 15 while advancing the paper in the paper feeding direction. The amount of light detected by the alignment sensor 15 is very small at an early stage of the scanning process but gradually increases as more of the sensing zone 16 is covered by the paper P. As a rear end portion of the paper P leaves the sensing zone 16, the sensing zone 16 becomes gradually uncovered by the paper P, and accordingly, the amount of light detected by the alignment sensor 15 gradually decreases.

If the leading end of the paper P is detected by the detector 18, the controller 19 aligns the detected leading end of the paper P with the nozzles disposed at the leading end of the head 13 and stops the feeding of the paper P.

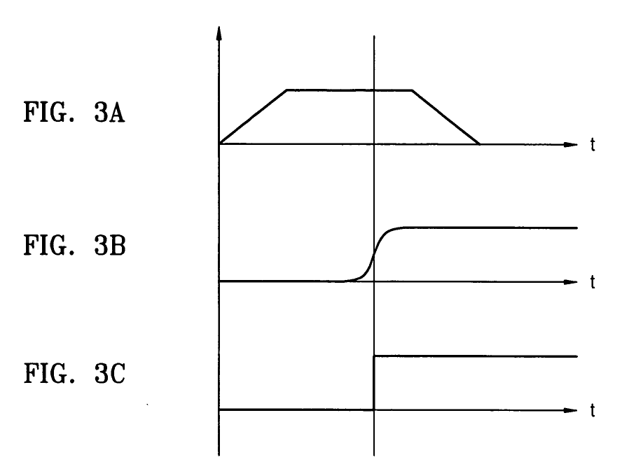

FIG. 3A illustrates an example of the variation of an operating state of each of the feeding rollers 12a and 12b during the time lapse from the time when the paper P is fed, to the time when the feeding of the paper P stops. FIG. 3B illustrates an example of the output signal of the alignment sensor 15. FIG. 3C illustrates an example of the output signal of the detector 18. Referring to FIG. 3B, the intensity of the optical signal of the alignment sensor 15 increases over time forming, for example, a sine curve when the alignment sensor 15 irradiates light onto the leading end portion of the paper P. The detector 18 calculates the width of the variation (i.e., gradient) of the output signal of the alignment sensor 15 and determines an edge of the paper P by detecting a point having a maximum gradient. When the alignment sensor 15 irradiates light onto the rear end portion of the paper P, the intensity of the output signal of the alignment sensor 15 decreases forming, for example, an inverse sine curve.

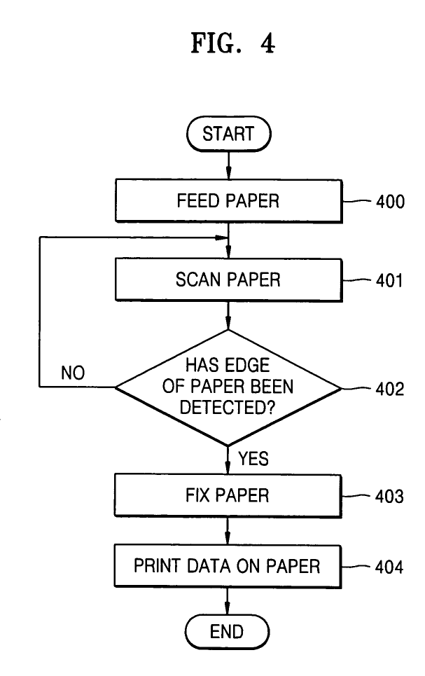

FIG. 4 is a flowchart illustrating a paper edge detection and printing process according to an exemplary embodiment of the present invention. Referring to FIG. 4, the paper P is fed and transferred in step 400. The optical sensor, or alignment sensor 15, scans the paper P every 1 ms in step 401. If a leading end of the paper P is detected as a result of the scanning process in step 402, the paper P is fed until the leading end of the paper P is aligned with the nozzles at the end of the head 13 in step 403. The head 13 then performs a printing process upon the paper P from the leading end to the rear end at step 404, without any margins on all four sides of the paper P.

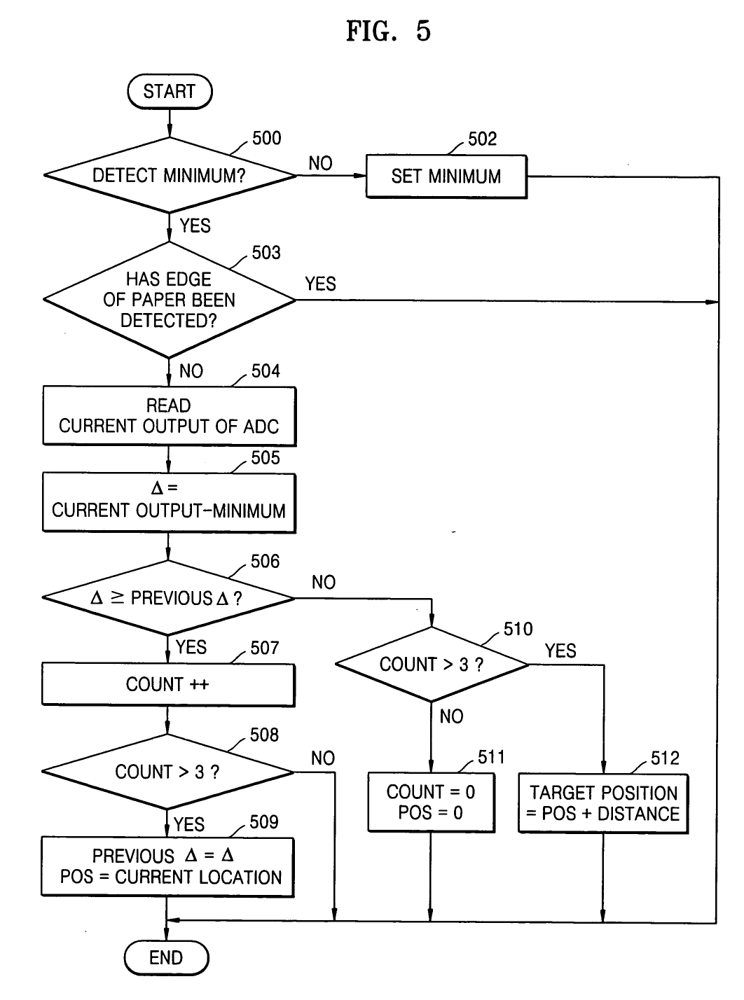

FIG. 5 is a detailed flowchart illustrating a process of detecting an edge of paper every 1 ms according to an exemplary embodiment of the present invention. Referring to FIG. 5, the detector 18 detects a minimum value from among values output from the ADC 17 in step 500. If no minimum value is detected from among the output values of the ADC 17, the detector 18 then sets, or determines a minimum value from among the output values of the ADC 17 in step 502. The minimum value is obtained when there is no paper detected. The detector 18 sets an average of n values, consecutively output from the ADC 17, as the minimum value. The amount of light received by the alignment sensor 15 can vary within a predetermined range when the paper P is tilted or the head 13, to which the alignment sensor 15 is attached, is unevenly driven. Accordingly, the output of the alignment sensor 15 and the output of the ADC 17 vary within a predetermined range. Therefore, it is necessary for the detector 18 to set a minimum value for the output of the ADC 17 as described above.

If the minimum value is detected from among the output values of the ADC 17 in step 500, the detector 18 then checks whether an edge of the paper P has been detected in step 503. If the edge of the paper P has been detected, the detector 18 ends the process. Otherwise, the detector 18 reads a current output value of the ADC 17 in step 504. The detector 18 subtracts the minimum value detected in step 500 from the current output value of the ADC 17 in step 505. Thereafter, the detector 18 compares the subtraction result (hereinafter, referred to as a current delta (Δ) value) with a previous delta value in step 506. If the current delta value is larger than or equal to the previous delta value, the detector 18 increases a counter value by 1 in step 507. When the current delta value is larger than the previous delta value, it is determined that the gradient of the variation of the output of the ADC 17 is increasing, as shown in FIG. 3B, as the paper P advances into the sensing zone 16 under the alignment sensor 15.

If the new counter value after step 507 is larger than a predetermined value, for example, 3, as determined in step 508, the previous delta value is replaced by the current delta value in step 509. At this point, a current location of the leading end of the paper P is detected and the detection result is stored as a parameter POS also in step 509. Here, the predetermined value, i.e., 3, is experimentally determined. More specifically, if the gradient of the waveform shown in FIG. 3B increases three times in a row, it is determined to have reached its substantially maximum value, and the edge of the paper P is determined to have been detected. If the counter value is not larger than 3 in step 508, the process is complete and ended.

If the current delta value is smaller than the previous delta value in step 506, and if the counter value is larger than 3 in step 510, a target position is determined as ‘POS +distance’ in step 512. Here, ‘distance’ indicates a distance between the alignment sensor 15 and the nozzles disposed at the leading end of the head 13. Specifically, the target position is the location of the paper P when the leading end of the paper P is aligned with the nozzles disposed at the leading end of the head 13.

If the counter value is smaller than 3 in step 510, it is determined that the waveform shown in FIG. 3B has been affected by noise, and the counter value and the parameter POS are all reset to 0 in step 511 such that the process is complete and ended.

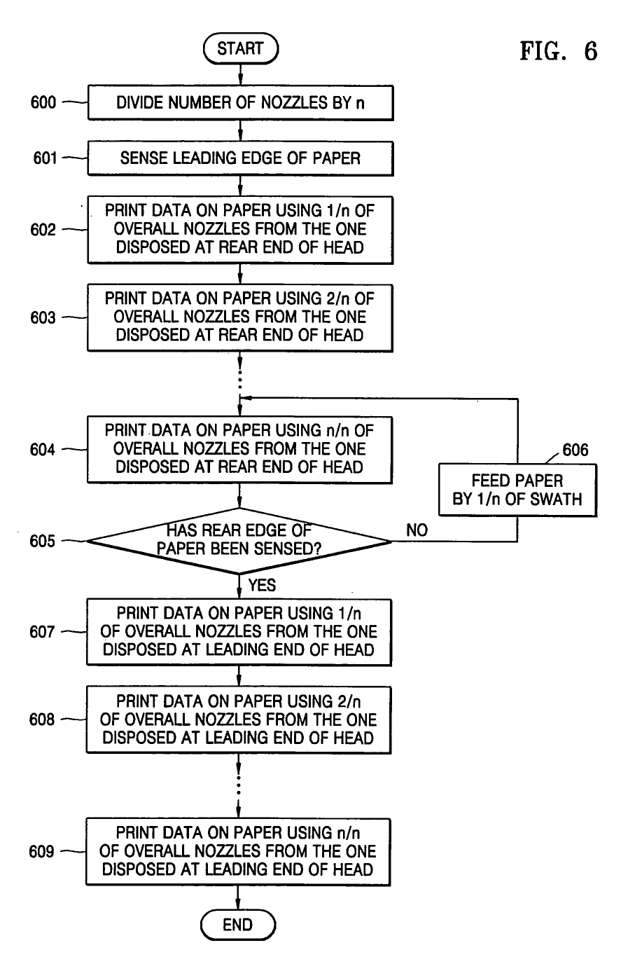

FIG. 6 is a flowchart of a borderless printing method according to an exemplary embodiment of the present invention. In the embodiment of the present embodiment illustrated in FIG. 6, it can be assumed that a printer driver transmits data to a printer on a swath-by-swath basis, and the printer uses nozzles after appropriately re-mapping them.

The number of total or overall nozzles, from a nozzle disposed at a leading end of the head 13, to a nozzle disposed at a rear end of the head 13, is divided by n into nozzle increments (1/nth) in step 600. If a leading end of paper P is sensed in step 601, the paper P is fed until the leading end thereof is aligned with the nozzles disposed at a rear end of the head 13, and data is then printed on the paper P by using one increment of the nozzles (1/nth of a total number of nozzles) disposed at the rear end of the head 13 in step 602. In steps 603 and 604, as the paper P travels, the data is consecutively printed on the paper by using the remaining nozzles in cumulative increments as provided in step 606 until all nozzles are being used. Once the rear end of the paper P is aligned with the nozzles disposed at the rear end of the head 13, the paper feed of steps 602 through 604 is stopped. At this point, once the rear end of the paper P is sensed at step 605, the paper is fixed and the data is printed on the paper by using the nozzles in steps 607 through 609, the number of which decreases by 1/nth of the total number of nozzles in the reverse of the steps 602 through 605.

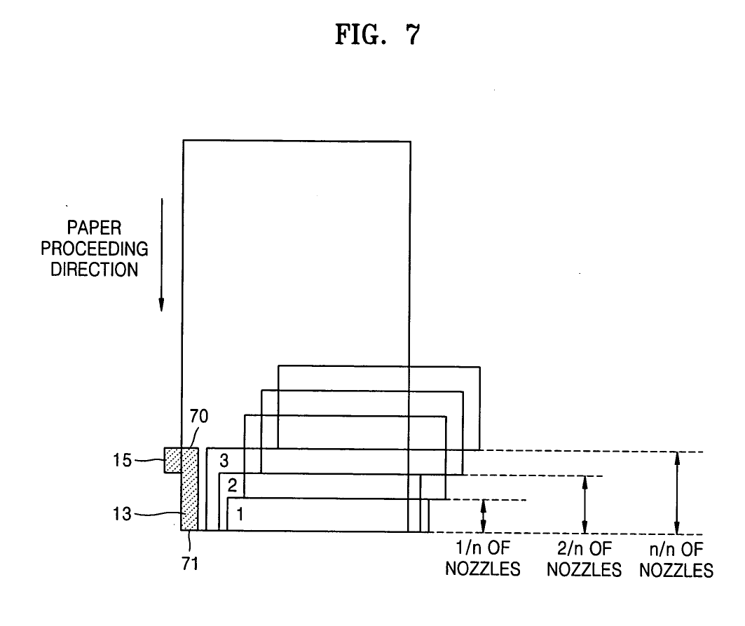

FIG. 7 illustrates a process example in accordance with an embodiment of the present invention for borderlessly printing data on a paper P from a leading end portion of the paper when n=3, such as, when the number of total or overall nozzles is divided by 3 in step 601 of FIG. 6. Referring to FIG. 7, reference numeral 1 represents a portion of the paper P, on which an image is printed by using one third of a total number of nozzles ranging from a nozzle disposed a rear end 71 of the head 13. Reference numeral 2 represents a portion of the paper P, on which the image is printed by using two thirds of the nozzles, and reference numeral 3 represents a portion of the paper P, on which the image is printed by using all of the nozzles disposed at the head 13.

Referring to FIG. 6, data is printed on the paper P while feeding the paper by 1/nth of a swath until a rear end of the paper is sensed in step 605. A process of sensing the rear end of the paper P is substantially the opposite of the process of sensing the leading end of the paper P. Specifically, a portion of the paper P, at which the gradient of the waveform of the output of the alignment sensor 15 decreases, can be determined as the rear end of the paper P, or the rear end of the paper can be determined by using an end-of-file (EOF) signal.

Once the rear end of the paper P is sensed, the paper is fixed and the data is printed on the paper n times by using the nozzles, the number of which decreases by 1/nth of the total number of nozzles beginning with the one disposed at the rear end 71 of the head 13.

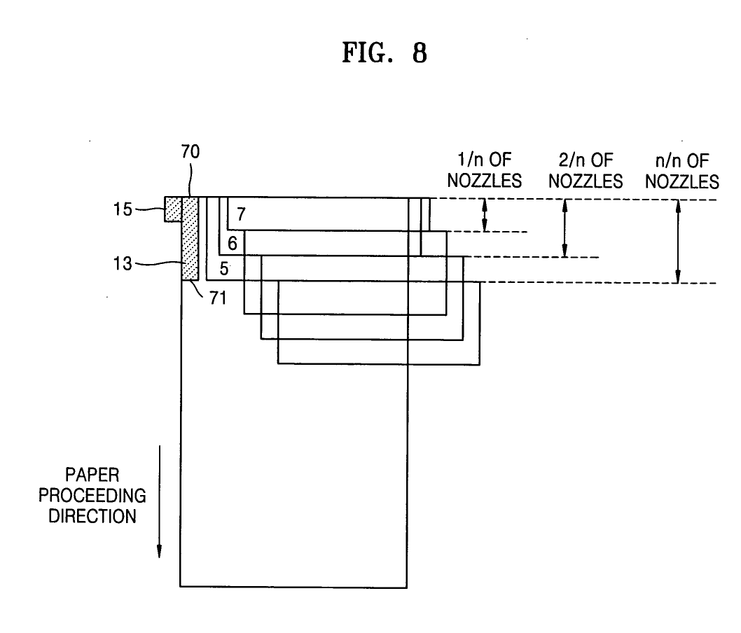

FIG. 8 illustrates a process example in accordance with an embodiment of the present invention for borderlessly printing data on a rear end portion of paper when n=3. Referring to FIG. 8, reference numeral 5 represents a portion of the paper P, on which data is printed using all of the nozzles. Reference numeral 6 represents a portion of the paper P, on which the data is printed using two thirds of the nozzles, and reference numeral 7 represents a portion of the paper P, on which the data is printed using one third of the nozzles at the head 13.

According to the present invention, it is possible to detect an edge of paper during feeding the paper, fix the paper at a target position, and print data on the paper. In the present invention, a current location of the paper is determined by comparing an increase in the output of an alignment sensor. Therefore, the edge of the paper can be more efficiently detected than in the prior art. In addition, it is possible to reduce the possibility of the data being printed outside the paper by precisely feeding the paper to be aligned with an end of an array of nozzles disposed at an end of a head.

While the invention has been shown and described with reference to certain exemplary embodiments thereof, it will be understood by those skilled in the art that various changes in form and details may be made therein without departing from the spirit and scope of the invention as defined by the appended claims.

1. A method of detecting an edge of paper comprising the steps of:
(a) feeding paper;
(b) outputting a sensing signal for the paper; and
(c) calculating a gradient of the sensing signal and detecting an edge of the paper based on the gradient of the sensing signal.

2. The method of claim 1, wherein in step (b), the sensing signal is periodically output.

3. The method of claim 2, further comprising the steps of:
obtaining the sensing signal by irradiating light on the paper; and
converting the amount of light reflected from the paper into an electric signal, wherein the intensity of the electric signal gradually increases as the paper advances into a predetermined zone in which light is irradiated on the paper.

4. The method of claim 3, wherein step (c) further comprises the step of:
detecting the edge of the paper when the gradient of the intensity of the electric signal reaches a substantially maximum value.

5. The method of claim 4, further comprising the step of:
digitizing the electric signal and comparing a current value of the digitized electric signal with a previous value of the digitized electric signal to determine the gradient of the intensity of the electric signal.

6. The method of claim 5, further comprising the step of detecting an identical sign of the gradient for a predetermined number of times to detect the edge of the paper.

7. The method of claim 1, further comprising the step of:
continuously moving the paper from a position where the edge of the paper is detected, to a position where the edge of the paper is aligned at a rear end of a plurality of nozzles used for printing.

8. An apparatus for detecting an edge of paper comprising:
a paper feeding unit which feeds paper;
an alignment sensor which outputs a sensing signal for the paper in response to a control signal;
a detector which calculates a gradient of the sensing signal and detects an edge of the paper based on the gradient of the sensing signal; and
a controller which controls speed of the paper feed by controlling the paper feeding unit and outputs the control signal to the alignment sensor.

9. The apparatus of claim 8, wherein the alignment sensor comprises an optical sensor that periodically outputs an optical signal onto the paper in response to the control signal, converts the amount of light reflected from the paper into an electric signal, and outputs the electric signal.

10. The apparatus of claim 9 further comprising:
an analog-to-digital converter which is disposed between the optical sensor and the detector to convert the electric signal into a digital signal.

11. The apparatus of claim 10, wherein the detector detects an edge of the paper when the gradient output from a comparison between two consecutive digital signals output from the analog-to-digital converter reaches a substantially maximum value.

12. A borderless printing method comprising the steps of:
(a) feeding paper;
(b) periodically outputting a sensing signal for the paper;
(c) calculating a gradient of the sensing signal and detecting an edge of the paper based on the gradient of the sensing signal;
(d) placing a leading edge of the paper under a rear end of a plurality of nozzles used for printing to fix the paper; and
(e) printing data on the paper by using at least one of the nozzles of the plurality of nozzles.

13. The borderless printing method of claim 12, further comprising the steps of:
obtaining the sensing signal by irradiating light on the paper; and
converting the amount of light reflected from the paper into an electric signal, wherein the intensity of the electric signal gradually increases as the leading edge of the paper advances into a predetermined zone in which light is irradiated on the paper.

14. The method of claim 13, wherein step (c) further comprises the step of:
detecting the leading edge of the paper when the gradient of the intensity of the electric signal reaches a substantially maximum value.

15. The method of claim 14, further comprising the step of:
digitizing the electric signal and comparing a current value of the digitized electric signal with a previous value of the digitized electric signal to determine the gradient.

16. The method of claim 15, wherein the leading edge of the paper is detected when the gradient has an identical sign for a predetermined number of times.

17. The method of claim 12, further comprising the steps of:
printing a predetermined number of times n on a portion of the paper from the leading edge of the paper to a position corresponding to the number of the overall nozzles without feeding the paper, wherein the printing is performed by;
dividing the number of the overall nozzles by the predetermined number n;
increasing the number of nozzles used for the printing by 1/nth of the total number of nozzles of said plurality of nozzles starting from the rear end of the nozzles; and
using the increased number of nozzles to print.

18. The method of claim 17, wherein the data of a total swath is printed on the rest of the paper while feeding the paper.

19. The method of claim 18 further comprising the step of;
sensing a rear edge of the paper by using the gradient of the sensing signal or an end-of-file (EOF) signal.

20. The method of claim 19, further comprising the steps of:
printing a predetermined number of times n on a portion of the paper from the rear edge of the paper to a position corresponding to the number of the overall nozzles without feeding the paper, wherein the printing is performed by;
decreasing the number of nozzles used for printing by 1/nth of the total number of nozzles of said plurality of nozzles starting from the rear end of the nozzles; and
using the decreased number of nozzles to print.
